(19) United States
(12) Patent Application Publication
(10) Pub. No.: US 2023/0008801 A1
(43) Pub. Date: Jan. 12, 2023

(54) INCREASED LIDAR APERTURE WITH REFRACTIVE OPTICAL ELEMENT

(71) Applicant: Seagate Technology LLC, Fremont, CA (US)

(72) Inventors: Daniel Joseph Klemme, Robbinsdale, MN (US); Daniel Aaron Mohr, Saint Paul, MN (US); Kevin A. Gomez, Eden Prairie, MN (US)

(21) Appl. No.: 17/862,949

(22) Filed: Jul. 12, 2022

Related U.S. Application Data
(60) Provisional application No. 63/220,694, filed on Jul. 12, 2021.

(51) Int. Cl. G01S 7/481; G01S 17/89; G01S 17/10; G01S 7/4861

(52) U.S. Cl. CPC G01S 7/4817; G01S 17/89; G01S 17/10; G01S 7/4861; G01S 17/931

(57) ABSTRACT

Method and apparatus for enhancing resolution in a light detection and ranging (LiDAR) system. In some embodiments, an emitter is used to emit light pulses at a first resolution within a baseline, first field of view (FoV). A specially configured optical element, such as a refractive optical lens, is activated responsive to an input signal to direct at least a portion of the emitted light pulses to an area of interest characterized as a second FoV within the first FoV. The second FoV is provided with a higher, second resolution. In some cases, all of the light pulses are directed through the optical element to the second FoV. In other cases, the first FoV continues to be scanned at a reduced resolution. A rotatable polygon, micromirrors and/or solid state array mechanisms can be used to divert the pulses to the optical element.

### RELATED APPLICATION

The present application makes a claim of domestic priority to U.S. Provisional Patent Application No. 63/220,694 filed Jul. 12, 2021, the contents of which are hereby incorporated by reference.

### SUMMARY

Various embodiments of the present disclosure are generally directed to a method and apparatus for enhancing resolution in a light detection and ranging (LiDAR) system.

In some embodiments, an emitter is used to emit light pulses at a first resolution within a baseline, first field of view (FoV). A specially configured optical element, such as a refractive optical lens assembly, is activated responsive to an input signal to direct at least a portion of the emitted light pulses to an area of interest characterized as a second FoV within the first FoV. The second FoV is provided with a higher, second resolution. In some cases, all of the light pulses are directed through the optical element to the second FoV. In other cases, the first FoV continues to be scanned at a reduced resolution. A rotatable polygon, micromirrors and/or solid state array mechanisms can be used to divert the pulses to the optical element.

These and other features and advantages of various embodiments can be understood from the following detailed description in conjunction with a review of the accompanying drawings.

### BRIEF DESCRIPTION OF THE DRAWINGS

FIG. 1 is a block representation of an active light detection system constructed and operated in accordance with various embodiments of the present disclosure.

FIG. 2 shows an emitter of the system in some embodiments.

FIGS. 3A and 3B show different types of output systems that can be used by various embodiments.

FIG. 4 shows a detector of the system in some embodiments.

FIG. 5 illustrates a field of view (FoV) established by the various embodiments.

FIG. 6 shows an arrangement that uses a specially configured lens assembly in conjunction with an output system to enhance the FoV performance from FIG. 5.

FIG. 7 shows a system that adaptively switches in a specially configured lens as in FIG. 6 to provide enhanced detection performance in some embodiments.

FIG. 8 depicts scan patterns that can be adaptively obtained by the system in accordance with some embodiments.

FIG. 9 depicts scan patterns that can be adaptively obtained by the system in accordance with other embodiments.

FIG. 10 shows a transmission and detection sequence of pulses generated and processed by various embodiments.

FIG. 11 is a sequence diagram for an enhanced resolution scan operation carried out in accordance with various embodiments.

FIG. 12 shows an adaptive resolution management system constructed and operated in accordance with further embodiments.

### DETAILED DESCRIPTION

Various embodiments of the present disclosure are generally directed to optimization of an active light detection system.

Light Detection and Ranging (LiDAR) systems are useful in a number of applications in which ranges (e.g., distances) from an emitter to a target are detected by irradiating the target with electromagnetic radiation in the form of light. The range is detected in relation to timing characteristics of reflected light received back by the system. LiDAR applications include topographical mapping, guidance, surveying, and so on. One increasingly popular application for LiDAR is in the area of autonomously piloted or driver assisted vehicle guidance systems (e.g., self driving cars, autonomous drones, etc.). While not limiting, the light wavelengths used in a typical LiDAR system may range from ultraviolet to near infrared (e.g., 250 nanometers, nm to 1500 nm or more). Other wavelength ranges can be used.

One commonly employed form of LiDAR is sometimes referred to as coherent pulsed LiDAR, which generally uses coherent light and detects the range based on detecting phase differences in the reflected light. Such systems may use a dual (IQ) channel detector with an I (in-phase) channel and a Q (quadrature) channel. Other forms of LiDAR systems can be used, however, including non-coherent light systems that may incorporate one or more detection channels. Further alternatives that can be incorporated into LiDAR systems include systems that sweep the emitted light using mechanical based systems that utilize moveable mechanical elements, solid-state systems with no moving mechanical parts but instead use phase array mechanisms to sweep the emitted light in a direction toward the target, and so on.

Various embodiments of the present disclosure are directed to a method and apparatus for generating light beams in a LiDAR system. As explained below, some embodiments use a light emission system in conjunction with a specially configured optical element, such as an assembly that incorporates one or more refractive lenses. The optical element is provided with a magnification capability designed such that the optical element reduces the total field of view (FoV) of the system by some factor but improves the optical aperture by nominally that same amount, thereby improving the range of the system.

In this way, the FoV can be scanned at a first resolution, and once a particular area of interest has been identified within the FoV, emphasis can be placed upon that area of interest at an enhanced, second resolution. The area of interest may be at an increased distance as compared to the baseline FoV.

In some embodiments, all of the emitted energy is switched (diverted) to the optical element so that the area of interest can be characterized as a smaller, more dense FoV. In other embodiments, a portion of the emitted energy is switched via the optical element so that a greater point density is supplied to the area of interest and a reduced point density is utilized within the baseline FoV. Different pulse configurations can be utilized for the pulses provided through the optical element to further distinguish those pulses that have been diverted.

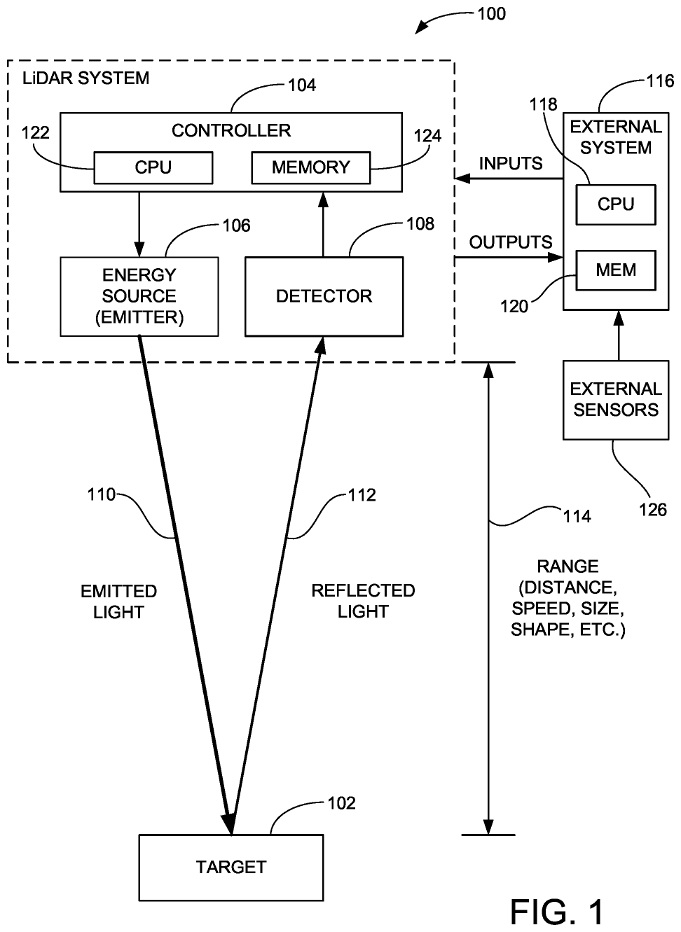

These and other features and advantages of various embodiments can be understood beginning with a review of FIG. 1, which provides a simplified functional representation of a LiDAR system 100 constructed and operated in accordance with various embodiments of the present disclosure. The LiDAR system 100 is configured to obtain range information regarding a target 102 that is located distal from the system 100. The information can be beneficial for a number of areas and applications including, but not limited to, topography, archeology, geology, surveying, geography, forestry, seismology, atmospheric physics, laser guidance, automated driving and guidance systems, closed-loop control systems, etc.

The LiDAR system 100 includes a controller 104 which provides top level control of the system. The controller 104 can take any number of desired configurations, including hardware and/or software. In some cases, the controller can include the use of one or more programmable processors with associated programming (e.g., software, firmware) stored in a local memory which provides instructions that are executed by the programmable processor(s) during operation. Other forms of controllers can be used, including hardware based controllers, digital signal processors (DSPs), field programmable gate arrays (FPGAs), system on chip (SOC) integrated circuits, application specific integrated circuits (ASICs), gate logic, reduced instruction set computers (RISCs), etc.

An energy source circuit 106, also sometimes referred to as an emitter or a transmitter, operates to direct electromagnetic radiation in the form of light pulses toward the target 102. A detector circuit 108, also sometimes referred to as a receiver or a sensor, senses reflected light pulses received back from the target 102. The controller 104 directs operation of the emitted light from the emitter 106, denoted by arrow 110, and decodes information from the reflected light obtained back from the target, as denoted by arrow 112.

Arrow 114 depicts the actual, true range information associated with the intervening distance (or other range parameter) between the LiDAR system 100 and the target 102. Depending on the configuration of the system, the range information can include the relative or absolute speed, velocity, acceleration, distance, size, location, reflectivity, color, surface features and/or other characteristics of the target 102 with respect to the system 100.

The decoded range information can be used to carry out any number of useful operations, such as controlling a motion, input or response of an autonomous vehicle, generating a topographical map, recording data into a data structure for further analysis and/or operations, etc. The controller 104 perform these operations directly, or can communicate the range information to an external system 116 for further processing and/or use.

In some cases, inputs supplied by the external system 116 can activate and configure the system to capture particular range information, which is then returned to the external system 116 by the controller 104. The external system can take any number of suitable forms, and may include a system controller (such as CPU 118), local memory 120, etc. The external system may form a portion of a closed-loop control system and the range information output by the LiDAR system 100 can be used by the external system 116 to adjust the position of a moveable element.

The controller 104 can incorporate one or more programmable processors (CPU) 122 that execute program instructions in the form of software/firmware stored in a local memory 124, and which communicate with the external controller 118. External sensors 126 can provide further inputs used by the external system 116 and/or the LiDAR system 100.

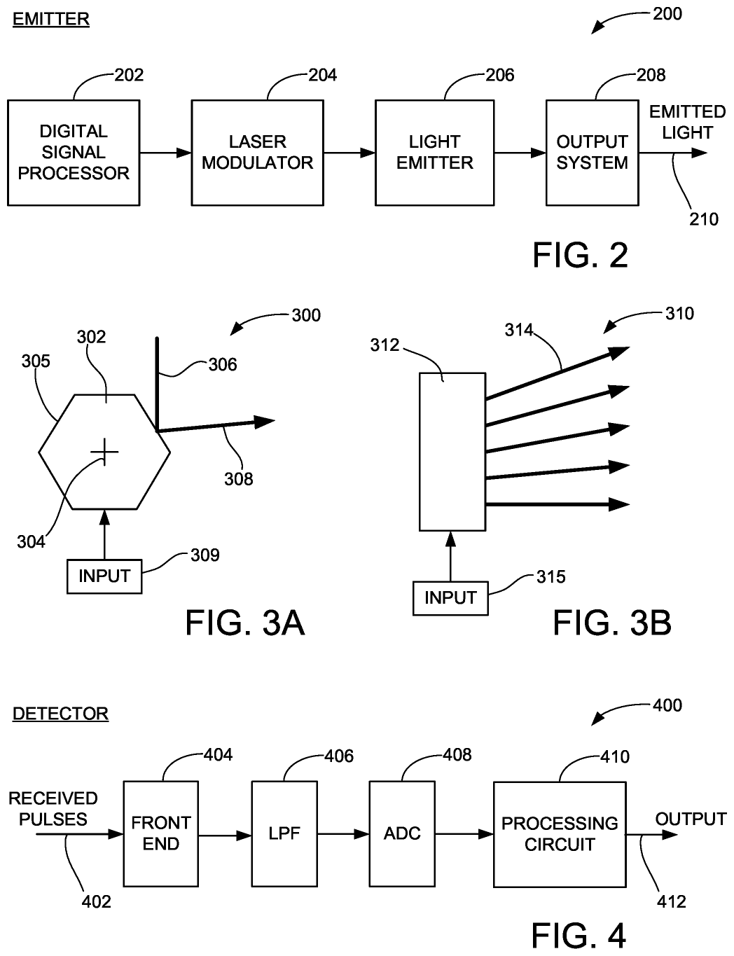

FIG. 2 depicts an emitter circuit 200 that can be incorporated into the system 100 of FIG. 1 in some embodiments. Other arrangements can be used so the configuration of FIG. 2 is merely illustrative and is not limiting. The emitter circuit 200 includes a digital signal processor (DSP) that provides adjusted inputs to a laser modulator 204, which in turn adjusts a light emitter (e.g., a laser, a laser diode, etc.) that emits electromagnetic radiation (e.g. light) in a desired spectrum. The emitted light is processed by an output system 208 to issue a beam of emitted light 210. The light may be in the form of pulses, coherent light, non-coherent light, swept light, etc.

FIGS. 3A and 3B show different aspects of some forms of output systems that can be used by the system of FIG. 2. Other arrangements can be used. FIG. 3A shows a system 300 that includes a rotatable polygon 302 which is mechanically rotated about a central axis 304 at a desired rotational rate. The polygon 302 has reflective outer surfaces 305 adapted to direct incident light 306 as a reflected stream 308 at a selected angle responsive to the rotational orientation of the polygon 302. The polygon is characterized as a hexagon with six reflective sides, but any number of different configurations can be used. By coordinating the impingement of light 306 and rotational angle of the polygon 302, the output light 308 can be swept across a desired field of view (FoV). An input system 309, such as a closed loop servo system, can control the rotation of the polygon 302.

FIG. 3B provides a system 310 with a solid state array integrated circuit device 312 configured to emit light beams 314 at various selected angles across a desired FoV. Unlike the mechanical system of FIG. 3A, the solid state array integrated circuit of FIG. 3B may be configured to have essentially no moving parts and instead uses phase array techniques to direct beams of emitted pulses. As before, a closed loop input system 315 can be used to control the scan rate, density, etc. of the output light 314. Other arrangements can be used as desired, so that the device 310 can alternatively be characterized as a DLP micromirror device having micro-mirrors that are selectively moved to direct the pulses, etc.

Regardless the configuration of the output system, FIG. 4 provides a generalized representation of a detector circuit 400 configured to process reflected light issued by the system of FIG. 2. The detector circuit 400 receives reflected pulses 402 which are processed by a suitable front end 404. The front end 404 can include optics, detector grids, amplifiers, mixers, and other suitable features to present input pulses reflected from the target. The particular configuration of the front end 404 is not germane to the present discussion, and so further details have not been included. It will be appreciated that multiple input detection channels can be utilized.

A low pass filter (LPF) 406 and an analog to digital converter (ADC) 408 can be used as desired to provide processing of the input pulses. A processing circuit 410 provides suitable signal processing operations to generate a useful output 412.

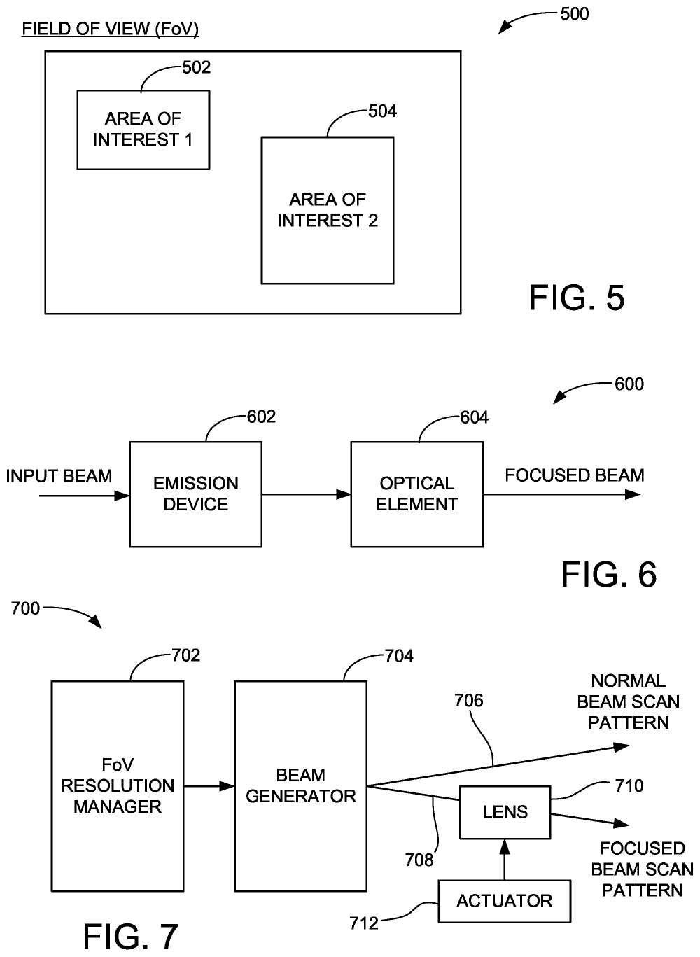

FIG. 5 depicts a field of view (FoV) of the various embodiments. This represents the down range detection area toward which light beams are emitted and from which light beams are returned when encountering targets. The FoV may be scanned in a raster pattern to generate a three-dimensional (3D) point cloud representation of the environment. Objects (targets) within the FoV can be detected and range information obtained.

In FIG. 5, different regions of interest are denoted at 502, 504, so that the scanning supplied by the system can be nominally uniform across the FoV or can be enhanced in these or other areas. The areas of interest 502, 504 may specifically correspond to particular targets, or may be particular areas within the larger FoV for which enhanced resolution is desired. A background area 506 within the FoV 500 that is outside the areas of interest 502, 504 may continue to receive scanning but at a corresponding reduced resolution. In other embodiments, substantially all of the energy over the FoV may be diverted to a specific area of interest, such as 502, so that the pulses previously spread out over the entire FoV are, at least during certain intervals, are directed wholly upon the area of interest 502. Multiple areas of interest can be selected so that the system alternately switches between higher resolution scans of both areas 502, 504. Priority can be assigned to one region over the other so that, for example, area 502 can be scanned some multiple number of times for each scan of area 504, etc.

FIG. 6 provides an emission system 600 configured to operate in accordance with some embodiments. The system includes an emission device 602 and a selectably usable optical element 604. The emission device 602 is an output element as described above (e.g., polygon, DLP array, solid-state array, etc.) to direct a beam of light over an FoV as in FIG. 5. The optical element 604 may be a refractive lens assembly or similar mechanism configured to direct the beam output from the device upon a selected area of interest. It will be noted that the optical element can take any number of suitable forms, including a prism, a lens pair (or multiple lenses), reflective elements, etc. Essentially, any type of imaging system, including systems formed from multiple lenses and associated devices, would be sufficient to carry out the described operations set forth herein.

The magnification of the beam provided by the element 604 restricts the total FoV in one or more orthogonal directions, such as in the vertical and/or horizontal directions as depicted in FIG. 5. However, concentrating the points in the selected area improves the response of the system by improving the range (e.g., depth) by a corresponding amount. In some cases, the system is selectable when desired for long range targeting, so that other system operational modes can be used at other times.

FIG. 7 shows a system 700 that can be incorporated into the system of FIG. 6 in some embodiments. An FoV resolution manager 702 provides closed loop control of the operation of a beam generator 704. During baseline operation, a normal beam scan pattern 706 is emitted by the generator 704 to rasterize the FoV (FIG. 5) at a first desired resolution. This may include a particular number of light pulses that are emitted per unit time spread out over the FoV.

At such time that the manager 702 identifies an area of interest (such as 502 in FIG. 5), at least a portion of the beam 706, denoted at 708, is directed through lens 710 to output a directed beam scan pattern for the area of interest. In some cases, the lens 710 can remain stationary and mechanical or solid-state mechanisms of the beam generator can be used to direct the beam through the lens; however, the lens can additionally or alternatively be moved as required using appropriate piezo, mechanical or electromechanical mechanisms to further direct the beam to the intended area. The movement mechanism(s) utilized to switch in the optical element 710 is generally represented by actuator 712.

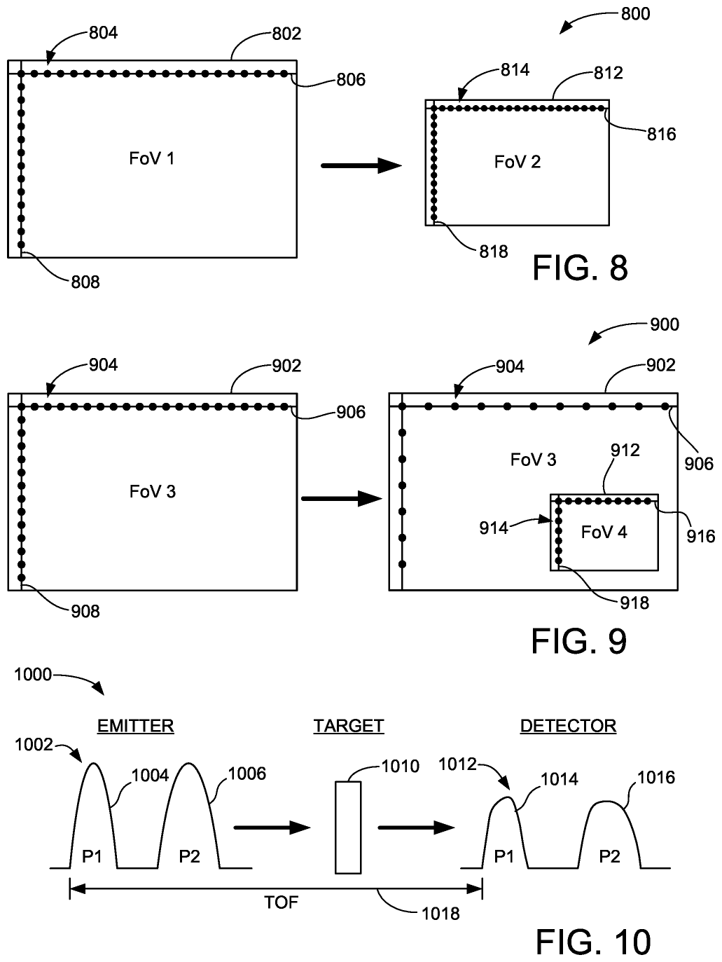

FIG. 8 shows a first scan response diagram 800 that can be obtained by some embodiments. A baseline field of view (FoV 1) is generally denoted at 802, and represents a first area being scanned by the system at a baseline resolution. In this simplified example, beam pulses 804 are rasterized along rows 806 and columns 808 corresponding to respective x and y axes. Other scanning patterns and densities can be used.

In this example, all of the energy from the emitter is diverted to an area of interest within the field 802 denoted as a second, higher resolution field of view (FoV 2). In this case, beams 814 correspond to the beams 804 but are redirected into the smaller area of field 812. As before, the beams 814 may be rasterized using an x-y pattern along rows 816, 818, although such is not necessarily required. As such, no beams 804 are emitted on the rest of the area of FoV 1 while FoV 2 is being scanned. In some cases, the optical element can be activated for a selected number of cycles after which the system can return to scanning the entirety of FoV 1 in order to maintain tracking information for targets that are within FoV 1 but are not within FoV 2.

FIG. 9 shows a second scan response diagram 900 in accordance with further embodiments. In this example, some but not all of the energy is switched to the area of interest by the optical element. More particularly, a baseline field 902 (FoV 3) is rasterized using beams 904 along x-y aligned rows and columns 906, 908 at a first density.

At such time that a field of interest within FoV 3 is identified, the optical element is switched in to scan field 912 (FoV 4) using beams 914 arranged along x-y rows and columns 916, 918. Fov 4 uses a subset of the pulses so that FoV 3 continues to be scanned albeit at a lower resolution while FoV 4 receives a higher resolution from the diverted pulses. The system can operate to switch between these various modes as often as required, including multiple times every second or other unit of elapsed time measure.

FIG. 10 depicts a pulse transmission and reflection sequence 1000 carried out in accordance with various embodiments. An initial set of pulses is depicted at 1002 having two pulses 1004, 1006 denoted as P1 and P2. Each pulse may be provided with a different associated frequency or have other characteristics to enable differentiation by the system. The emitted pulses 1004, 1006 are quanta of electromagnetic energy that are transmitted downrange toward a target 1010.

Reflected from the target is a received set of pulses 1012 including pulses 1014 (pulse P1) and 1016 (pulse P2). The time of flight (TOF) value for pulse P1 is denoted at 1018. Similar TOF values are provided for each pulse in turn.

The received P1 pulse 1014 will likely undergo frequency doppler shifting and other distortions as compared to the emitted P1 pulse 1004. The same is generally true for each successive sets of transmitted and received pulses such as the P2 pulses 1006, 1016. Nevertheless, the frequencies, phase and amplitudes of the received pulses 1014, 1016 will be processed as described above to enable the detector circuit to correctly match the respective pulses and obtain accurate distance and other range information.

In some cases, the emitted/received pulses such as P1 can represent the baseline pulses in the baseline field (e.g., FoV 1 and FoV 3 described in FIGS. 8-9), and the emitted/received pulses such as P2 can represent the higher resolution pulses in the area of interest (e.g., FoV 2 and FoV 4). Different frequencies, wavelengths, amplitudes, gain characteristics, pulse sequence counts, and other adjustments can be made to distinguish and process the respective pulses in the various areas.

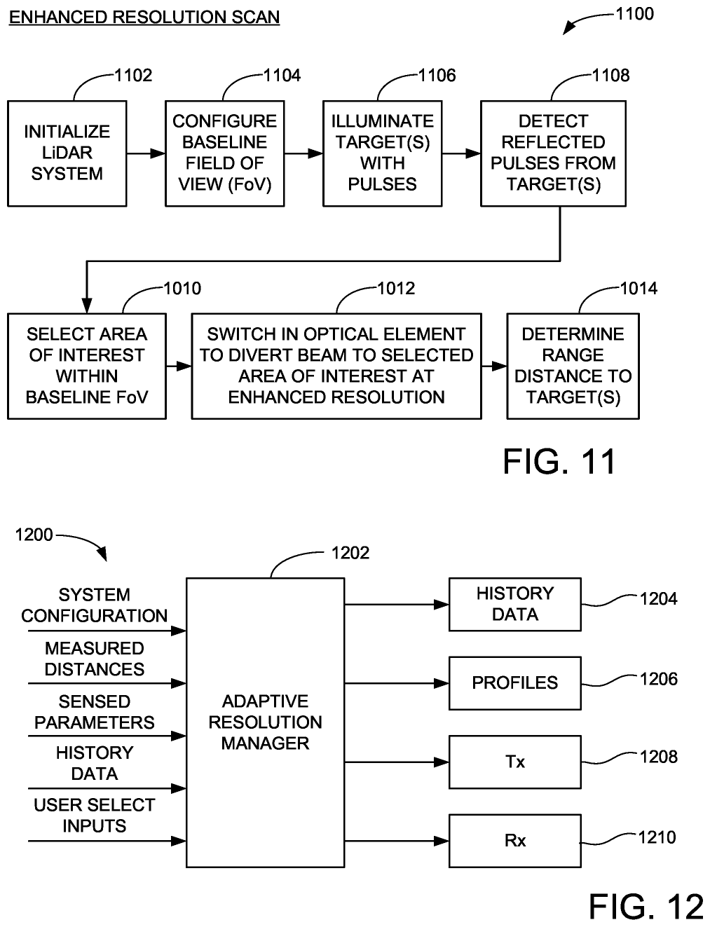

FIG. 11 is a sequence diagram 1100 for an enhanced resolution scan operation carried out in accordance with various embodiments described herein. Other operational steps can be incorporated into the sequence as required, so the diagram is merely illustrative and is not limiting.

A LiDAR system such as 100 in FIG. 1 is initialized at block 1102. An initial, baseline field of view (FoV) is selected for processing at block 1104. This will include selection and implementation of various parameters (e.g., pulse width, wavelength, raster scan information, density, etc.) to accommodate the baseline FoV.

Thereafter the system commences with normal operation at block 1106. Light pulses are transmitted to illuminate various targets within the FoV as described above using the emitters as variously described in FIGS. 1-2 and 6-7. Reflected pulses from various targets within the baseline FoV are detected at block 1108 using a detector system as provided including at FIGS. 1 and 4; see also FIG. 10.

An area of interest within the baseline FoV is next selected at 1010. This can be carried out based on a number of inputs, including range information obtained from 1108, external sensor information, user input, etc. Regardless, a particular field of interest is identified to receive enhanced scanning resolution. In response, the optical element (e.g., FIGS. 6-7) is switched in at block 1012 to direct beams at the selected area at an enhanced resolution, such as described above in FIGS. 8-9. Range information for targets detected within the enhanced area is obtained during block 1014.

As noted above, the system can cycle to provide different scanning patterns for different areas as required. FIG. 12 shows an adaptive resolution management system 1200 that can be incorporated into the system 100 of FIG. 1 in some embodiments. The system 1200 includes an adaptive resolution manager circuit 1202 which operates to implement the enhanced resolution scans in the selected fields of interest within a baseline FoV as described above. The manager circuit 1202 can be incorporated into the controller 104 such as a firmware routine stored in the local memory 124 and executed by the controller processor 122.

The manager circuit 1202 uses a number of inputs including system configuration information, measured distance for various targets, various other sensed parameters from the system (including external sensors 126), history data accumulated during prior operation, and user selectable inputs. Other inputs can be used as desired.

The manager circuit 1202 uses these and other inputs to provide various outputs including accumulated history data 1204 and various profiles 1206, both of which can be stored in local memory such as 124 for future reference. The history data 1204 can be arranged as a data structure providing relevant history and system configuration information. The profiles 1206 can describe different pulse set configurations with different numbers of pulses at various frequencies and other configuration settings, as well as other appropriate gain levels, ranges and slopes for different sizes, types, distances and velocities of detected targets.

The manager circuit 1202 further operates to direct various control information to an emitter (transmitter Tx) 1208 and a detector (receiver Rx) 1210 to implement these respective profiles. It will be understood that the Tx and Rx 1208, 1210 correspond to the various emitters and detectors described above. Without limitation, the inputs to the Tx 1208 can alter the pulses being emitted in the area of interest (including actuation signals to selectively switch in the specially configured lens or other optical element), and the inputs to the Rx 1210 can include gain, timing and other information to equip the detector to properly decode the pulses from the enhanced resolution area of interest.

As described previously, different gain ranges can be selected and used for different targets within the same FoV. Closer targets within the point cloud can be provided with one range with a lower slope and magnitude values to obtain optimal resolution of the closer targets, while at the same time farther targets within the point cloud can be provided with one or more different gain ranges with higher slopes and/or different magnitude values to obtain optimal resolution of the farther targets.

It can now be understood that various embodiments provide a LiDAR system with the capability of emitting light pulses over a selected FoV, along with a specially configured optical element that, when switched into the system, directs the emitted light to a reduced area of interest within the FoV with a corresponding aspect of range. Any number of different alternatives will readily occur to the skilled artisan in view of the foregoing discussion.

While coherent, I/Q based systems have been contemplated as a basic environment in which various embodiments can be practiced, such are not necessarily required. Any number of different types of systems can be employed, including solid state, mechanical, DLP, etc.

It is to be understood that even though numerous characteristics and advantages of various embodiments of the present disclosure have been set forth in the foregoing description, together with details of the structure and function of various embodiments of the disclosure, this detailed description is illustrative only, and changes may be made in detail, especially in matters of structure and arrangements of parts within the principles of the present disclosure to the full extent indicated by the broad general meaning of the terms in which the appended claims are expressed.

What is claimed is:

1. An apparatus comprising:
an emitter of a LiDAR system configured to emit light pulses at a first resolution within a baseline, first field of view (FoV); and
a selectable optical element that, in response to an activation signal, diverts at least a portion of the emitted light pulses to a reduced, second FoV within the first FoV at a corresponding higher, second resolution.

2. The apparatus of claim 1, wherein the optical element comprises a refractive optical lens.

3. The apparatus of claim 1, further comprising an actuator that mechanically moves the selectable optical element to receive the at least a portion of the emitted light pulses.

4. The apparatus of claim 1, further comprising a rotatable polygon that selectively directs the at least a portion of the emitted light pulses from the emitter to the selectable optical element.

5. The apparatus of claim 1, further comprising a solid state array integrated circuit device that selectively directs the portion of the emitted light pulses from the emitter to the refractive optical lens.

6. The apparatus of claim 1, wherein all of the emitted pulses from the emitter are directed to the second FoV so that no pulses are directed outside the second FoV.

7. The apparatus of claim 1, wherein a first portion of the emitted pulses from the emitter are directed to the second FoV and a remaining second portions of the emitted pulses continued to be directed to the first FoV outside the second FoV at a reduced density.

8. The apparatus of claim 1, wherein the light pulses are rasterized along orthogonal x-y axes in rows and columns in both the first FoV and the second FoV.

9. The apparatus of claim 1, wherein the second FoV is selected based on range information obtained using a detector that detects reflected pulses from the first FoV.

10. The apparatus of claim 9, wherein the first FoV covers at least one target at a first distance from the emitter, and wherein the second FoV is selected to cover an area within the first FoV that is at a greater second distance from the emitter to provide a long range targeting mode of operation.

11. The apparatus of claim 1, further comprises a control circuit configured to adaptively switch in and out the optical element to cyclically scan the second FoV and scan the entirety of the first FoV in sequence.

12. The apparatus of claim 1, wherein the emitter is configured to generate a first set of pulses having a first set of waveform characteristics that are not directed through the optical element and a second set of pulses having a different, second set of waveform characteristics that are directed through the optical element.

13. A method, comprising:
using an emitter of a LiDAR system to emit light pulses at a first resolution within a baseline, first field of view (FoV);
activating an optical element responsive to an activation signal; and
using the activated optical element to direct at least a portion of the emitted light pulses from the emitter within a second FoV contained within and having a reduced size as compared to the first FoV to provide a corresponding higher, second resolution within the second FoV.

14. The method of claim 13, further comprising decoding range information from a target in the first FoV and generating the activation signal responsive to the decoded range information.

15. The method of claim 13, comprising using a mechanical actuator to direct the at least a portion of the emitted light pulses from the emitter through a refractive optical lens.

16. The method of claim 13, wherein all of the emitted light pulses from the emitter are diverted through the optical element so that the same number of pulses are projected into the second FoV and none of the pulses extend beyond the second FoV.

17. The method of claim 13, wherein a first portion of the emitted light pulses from the emitter are diverted through the optical element to the second FoV and a remaining second portion of the emitted pulses from the emitter bypass the optical element and are projected to the first FoV in an area surrounding the second FoV at a reduced density as compared to a density of the first portion in the second FoV.

18. The method of claim 13, further comprising using at least a selected one of a rotatable mirrored polygon, a solid state array integrated circuit device, or a DLP micromirror device to direct the at least a portion of the emitted light pulses through the optical element.

19. The method of claim 13, further comprising rasterizing the emitted light pulses along orthogonal x-y axes in rows and columns in both the first FoV and the second FoV.

20. The method of claim 13, wherein the first FoV covers at least one target at a first distance from the emitter, and wherein the second FoV is selected to cover an area within the first FoV that is at a greater second distance from the emitter to provide a long range targeting mode of operation.
